(19) United States
(12) Patent Application Publication
(10) Pub. No.: US 2022/0348450 A1
(43) Pub. Date: Nov. 3, 2022

(54) BACK WOODS BOTTLE CAPPER WITH HEX ATTACHMENT

(71) Applicant: Trevor NOWOSELSKY, East Yarker (CA)

(72) Inventor: Trevor NOWOSELSKY, East Yarker (CA)

(21) Appl. No.: 17/243,924

(22) Filed: Apr. 29, 2021

(51) Int. Cl. B67B 3/20

(52) U.S. Cl. CPC B67B 3/2006

(57) ABSTRACT

Embodiments of the invention as disclosed herein relate to a small, portable and scalable bottle capper. The capper has an essentially domed structure. The upper part of the domed structure is adapted to cooperate with a manually-controlled or manually operated device such as a drill. The lower part of the domed structure is adapted to cooperate with a cap to be applied to a bottle or jar. In operation, the caps to be applied to bottles or jars are arranged on a surface with their upper edges in an upper position. The capper, in accordance with the various embodiments of the invention, is lowered onto a cap. The outer edges of the cap engage with the inner edges of the lower part of the domed structure in a friction fit relationship.

### FIELD OF THE INVENTION

The present invention relates generally to the field of automated bottle capper devices, specifically to bottle capper devices having drill bit or hex attachment.

### BACKGROUND

U.S. Pat. No. 7,387,049 (Ver HageGlenn) discloses an animal water feeding bottle cap handling system. The invention relates to a power tool for handling screw cap animal feeding bottles having straight and angled water delivery tubes. The hand-held cap removal tool captures the perimeter of the water bottle cap for automatic capping or de-capping. The cap removal tool accommodates straight and angled water delivery tubes and most popular water bottle cap sizes. The top of the tube with the annular collar has a hex plug for insertion of a hex shaft for press fit or weld to the power equipment part of the handling system.

KR. Pat. Document 2019/0108705 (Myung-hee) discloses a chuck for capping machine. The chuck for a capping machine is to couple or separate a cap of a container such as a plastic bottle from the container, and comprises a connection bit, a first holder, a second holder, and a third holder. One side of the connection bit is formed in a hexagonal bit shape to be mounted on a drill chuck of a power tool.

U.S. Pat. No. 5,851,042 (BankutyNicholas) discloses a collet for gripping A collet to be used in conjunction with a container capping device used primarily in the packaging industry, more particularly for gripping threaded container caps in preparation for the rotation of the caps onto threaded containers. The structure comprises separately pivoting segments for engaging the container cap without significant flexture of the segments.

U.S. Pat. No. 8,220,225 (Zemlin) discloses a capping chuck assembly. A capping chuck assembly embodying the present invention comprises an outer chuck housing, and inner, central guide disc upon which a plurality of circumferentially spaced gripper segments are mounted. Each gripper segment includes an inner jaw portion for engagement with an associated closure, and an outer cam surface. The outer chuck housing defines a plurality of inwardly facing, cam drive surfaces positioned for respective engagement with the outer cam surfaces of the gripper segments, so that rotational drive of the outer chuck housing collectively drives the gripper segments and guide disc to urge the segments radially into engagement with an associated closure.

U.S. Pat. Appl. 2018/0155173 (Scott) discloses a capping chuck assembly. A bottle capping chuck that uses serrated segments with a cap torque ramp angle to grip and torque a bottle cap combined with other segments that utilize holding segments both combining to eliminate slippage and stripping and holding of bottle caps during a bottle capping process.

U.S. Pat. No. 8,161,714 (Data) discloses a capping chuck. A capping chuck for a bottle capping machine is capable of applying a pre-defined torque to a cap and reducing top load during application. The capping chuck includes a drive gear mechanically connected to a clutch. The clutch controls the torque transmitted to a gripper head through a driveshaft. The gripper head secures the cap to the bottle, and includes a substantially continuous perimeter wall surrounding a plunger that moves under load in a direction parallel to the longitudinal axis of the driveshaft.

U.S. Pat. No. 5,327,697 (Kent) discloses a chuck for a capping machine. An improved chuck for a bottle capper having a torque trigger with vertically set trigger pins capable of withstanding high torques prior to shearing. Further an apparatus to precisely set the application torque of the capping chuck is provided. This apparatus uses a stem head about which a clamp collar and a scale collar are placed.

EP. Pat Doc. 3,034,430 (Guarnieri) discloses a cap for closing a bottle and the like and corresponding cap cover. A cap assembly for closing a bottle or the like comprises a cap body (2) adapted to be screwed onto a threaded bottle (10), wherein the cap body (2) is protected by a corresponding cap cover (6) of the double-walled type. The cap cover (6) is provided with retention means that comprise a circumferential tab (12) that protrudes from the lower rim of the cap cover (6) and are adapted to retain the cap cover (6) with respect to the cap (1).

U.S. Pat. No. 10,815,109 (Piramoon) discloses a closure tool for a centrifuge sample container and method for removing a closure from a centrifuge sample container. A tool for removing first and second centrifuge bottle closure members from a centrifuge bottle includes a tool head including an aperture sized and shaped to receive a protruding portion of the first centrifuge bottle closure member. The tool further includes an elongate shaft extending from the tool head to a distal end and including a tapered portion adjacent the distal end. The tapered portion is sized and shaped to be at least partially inserted in a recessed portion of the second centrifuge bottle closure member. The aperture is configured to transfer torque to the first centrifuge bottle closure member during a rotating operation of the tool and the tapered portion is configured to exert an output force on the second centrifuge bottle closure member during a prying operation of the tool.

All documents cited herein are incorporated by reference.

None of the above cited documents, alone or in combination satisfy the need for a simple but scalable device that can be used to easily used for closing bottles, jars or similar containers by applying caps and applying and rotating preformed threaded caps using a manually-controlled or manually operated device.

### BRIEF SUMMARY

It is an object of the invention to provide a bottle capper with hex attachment.

In accordance with an aspect of the invention there is provided a bottle capper device for applying caps to bottles or jars, said capper comprising: an essentially cylindrical structure, said structure having: an upper portion having an upper domed surface; a shaft member, extending vertically from said domed surface; a lower portion contiguous with said upper portion, said lower portion having defining within it an interior cavity having an interior diameter, an upper surface and an internal vertical edge; and a plurality of vertical splines in spaced apart relationship around said internal vertical edge, wherein said interior diameter of said interior cavity corresponds to an external diameter of said cap and said plurality of vertical splines on said internal vertical edge of said lower portion of said capper corresponds to a plurality of vertical splines of an outer edge of said cap.

In accordance with another aspect of the invention there is provided a method of capping a bottle or a jar, using the device as described above, said method comprising: (i) selecting an appropriately sized capper, having an interior cavity that is sized and dimensioned to accommodate said cap to be torqued to said bottle or jar; (ii) arranging one or more of said caps on a flat surface with said tops of said caps uppermost; (iii) securing shaft member of the capper to a manually-controlled or manually operated device; (iv) engaging said interior cavity of said capper with one of said one or more caps; (v) positioning said capper over said bottle or jar to be capped; and (vi) applying a torquing force by activation of said manually-controlled or manually operated device.

In accordance with yet another aspect of the invention there is provided a kit for capping one or more bottles or jars, said kit comprising: two or more capper devices, for torquing two or more differently dimensions caps, each capper device comprising: an essentially cylindrical structure, said structure having: —an upper portion having an upper domed surface; a shaft member, extending vertically from said domed surface; a lower portion contiguous with said upper portion, said lower portion having defining within it an interior cavity having an interior diameter, an upper surface and an internal vertical edge; and a plurality of vertical splines in spaced apart relationship around said internal vertical edge, wherein one of said capper devices has a first interior diameter that corresponds to an external diameter of a cap, and at least one other of said capper devices has an interior diameter that is greater or lesser than the first internal diameter.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

FIG. 1 illustrates a perspective aspect of the subject matter in accordance with one embodiment of the invention.

FIG. 2 illustrates a cross sectional aspect of the subject matter in accordance with one embodiment of the invention.

FIGS. 3A, 3B and 3C illustrate perspective, cross sectional and side aspects of the subject matter in accordance with one embodiment of the invention.

FIG. 4 illustrates a side aspect of the subject matter in accordance with one embodiment of the invention.

FIG. 5 illustrates a side aspect of the subject matter in accordance with another embodiment of the invention.

FIG. 6 illustrates a side aspect of the subject matter in accordance with an alternative embodiment of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

Embodiments of the invention as disclosed herein relate to a small, portable and scalable bottle capper. The capper has an essentially domed structure. The upper part of the domed structure is adapted to cooperate with a manually-controlled or manually operated device such as a drill. The lower part of the domed structure is adapted to cooperate with a cap to be applied to a bottle or jar.

In operation, the caps to be applied to bottles or jars are arranged on a surface with their upper edges in an upper position. The capper, in accordance with the various embodiments of the invention, is lowered onto a cap. The outer edges of the cap engage with the inner edges of the lower part of the domed structure in a friction fit relationship.

The capper, containing a cap having inner threads, is then lined up in a cooperating relationship with a bottle of jar having corresponding outer threads. The upper part of the domed structure, that is connected to a manually-controlled or manually operated device such as a drill, is activated. The torque generated by the manually-controlled or manually operated device transfers the force via the capper to the cap, thereby rotating the cap onto the battle or jar.

Certain embodiments of the invention have the entire device having the dome and drill bit or hex attachment fabricated as a unitary structure. The embodiments of the invention may be fabricated from stainless steel. Regarding the specific structure of some embodiments of the invention, the capper may have internal splines that correspond to matching splines on the outer surface of the caps or lids. Embodiments of the invention typically have a retainer ring, such as an o-ring, to provide a friction fit and thereby hold the cap in place. The upper portion of the domed structure typically has a hex style drill bit end, for insertion into a standard drill.

The various embodiments of the invention can be used in a plurality of applications. For example, in bottling facilities that produce: maple syrup; artisan liquid soaps; craft spirits; essential oils; and the like.

The expected market for embodiments of the invention would likely be artisan produces having small production line. The cappers as discloses will improve bottling efficiencies and result in a more ergonomic process for the hands, fingers and arms of the bottlers.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

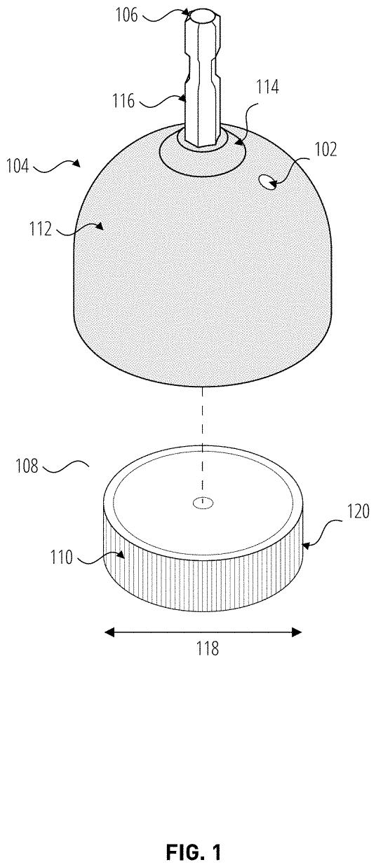

FIG. 1 illustrates a perspective view of a capper 104 in accordance with an embodiment of the invention.

The capper 104 can be seen to have a domed upper portion 112. The domed upper portion 112 of the capper 104 contains a member that is adapted to cooperate with a manually-controlled or manually operated device such as a drill. The embodiment shown in FIG. 1 illustrates the domed upper portion 112 connected to a drill bit shaft member 116, typically having a hex configuration 106 via a connection member 114.

The domed upper portion 112 typically has an air vent 102 to aid in the insertion and removal of the bottle cap 108 into the capper 104.

The capper 104, is lowered onto a cap, aligned as indicated. In the illustrated embodiment, the outer edges of the cap have external vertical splines 110 that form a friction fit with the capper 104.

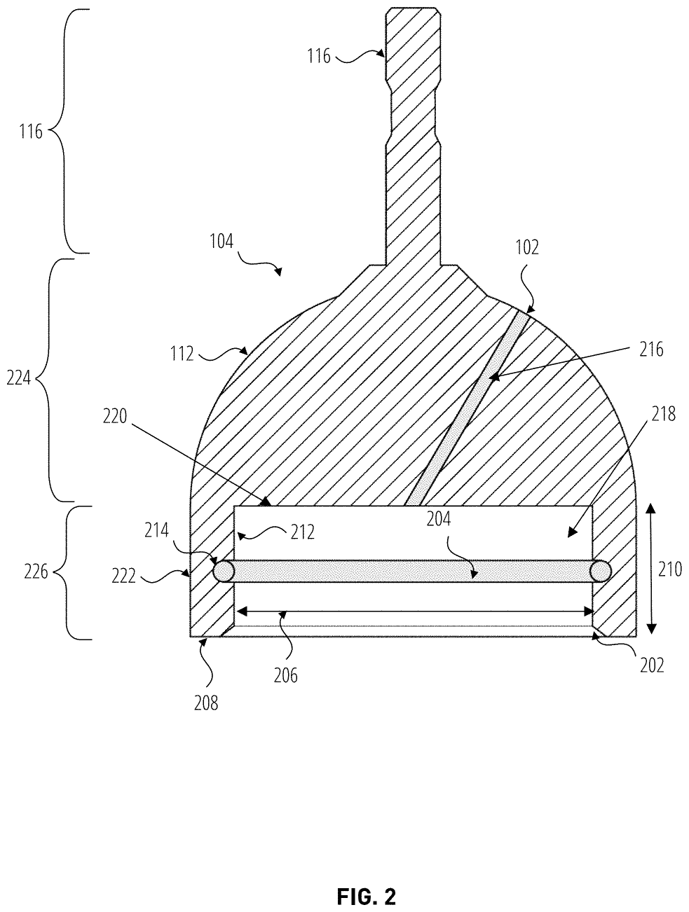

FIG. 2 illustrates a cross sectional view of a capper 104 in accordance with an embodiment of the invention. The capper 104 has a drill bit shaft member 116, an upper portion 224 and a lower portion 226. This particular embodiment the capper 104 has a domed upper portion 112 having a drill bit shaft member 116 and air vent 102 as described in FIG. 1 can be seen.

The capper 104 has an interior cavity 218 to receive the bottle cap 108 to be applied. The interior cavity 218 has an upper surface 220 and an internal vertical edge 212. The internal height 210 of the interior cavity 218 is defined by the upper surface 220 and the lower edge 208 of the capper 104. The internal diameter 206 of the interior cavity 218 is defined by the internal vertical edge 212 of the interior cavity 218.

The internal vertical edge 212 of the interior cavity 218 is joined to the lower edge 208 by a chamfered inner edge 202. The positioning of the chamfered inner edge 202 assisting in the insertion of the bottle cap 108 into the interior cavity 218 of the capper 104.

A retaining ring, such as an o-ring 204, is embedded within a retaining ring channel 214 that is positioned between the internal vertical edge 212 and the outer lower surface 222 of the capper 104, approximately midway between the lower edge 208 and the upper surface 220 of the interior cavity 218.

A vent channel 216, connecting the air vent 102 to the upper surface 220 of the interior cavity 218 can be seen.

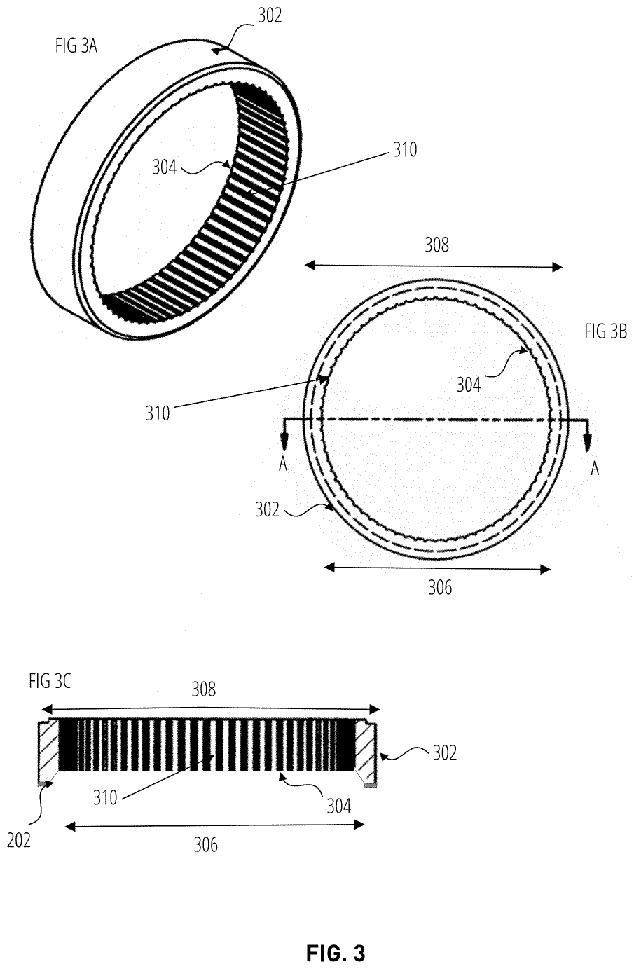

FIGS. 3A, 3B, and 3C show perspective, cross sectional and side aspects of the subject matter in accordance with one embodiment of the invention.

FIG. 3A illustrates a perspective view of the lower portion of the capper 104. A portion of the outer capper engagement surface 302 that corresponds to an inner capper engagement surface 304 is illustrated. In the embodiment shown, the inner capper engagement surface 304 comprises numerous internal vertical splines 310 that correspond to external vertical splines 110 (not shown) on the bottle cap 108. The o-ring 204 and chamfered inner edge 202 is also not illustrated in this embodiment.

FIG. 3B illustrates a horizontal cross-sectional view of the lower portion of the capper 104 in the region of the interior cavity 218. The outer capper engagement surface 302 and corresponding inner capper engagement surface 304 can be seen, the inner capper engagement surface 304 having internal vertical splines 310. The inner diameter 306 of the interior cavity 218 is shown as is the outer diameter 308 of the lower portion of the capper 104.

FIG. 3C illustrates a vertical cross-sectional view of the lower portion of the capper 104 taken in the direction as indicated by A-A in FIG. 3B. The chamfered inner edge 202, joining the lower edge 208 to the internal vertical edge 212, is also shown.

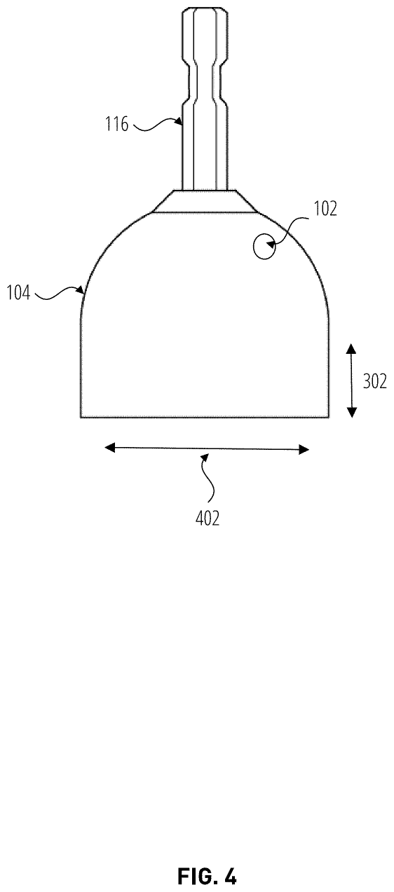

FIG. 4 illustrates a side view of a capper 104 in accordance with an embodiment of the invention. The air vent 102 and drill bit shaft member 116 can be seen as previously described. The size and proportions of the illustrated capper 104, including the dimensions of the interior cavity 218, are fabricated to accommodate a bottle cap 108 having a small inner diameter 402.

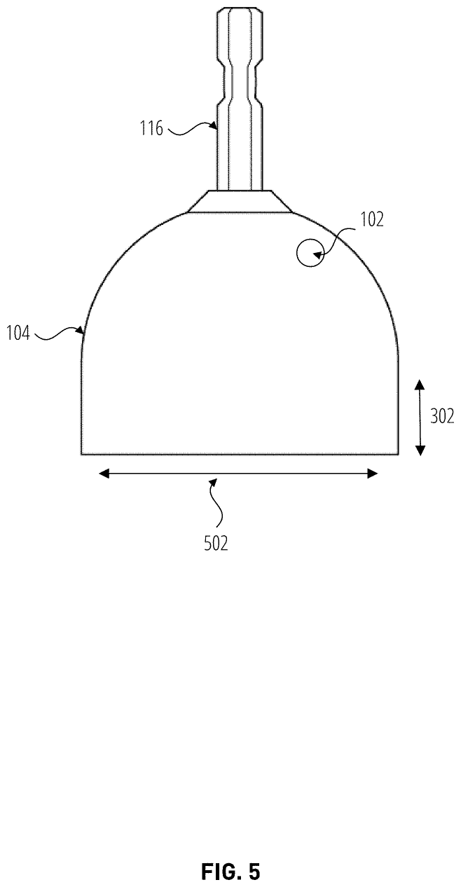

FIG. 5 illustrates a side view of a capper 104 in accordance with an embodiment of the invention. The air vent 102 and drill bit shaft member 116 can be seen as previously described. The size and proportions of the illustrated capper 104, including the dimensions of the interior cavity 218, are fabricated to accommodate a bottle cap 108 having a medium inner diameter 502.

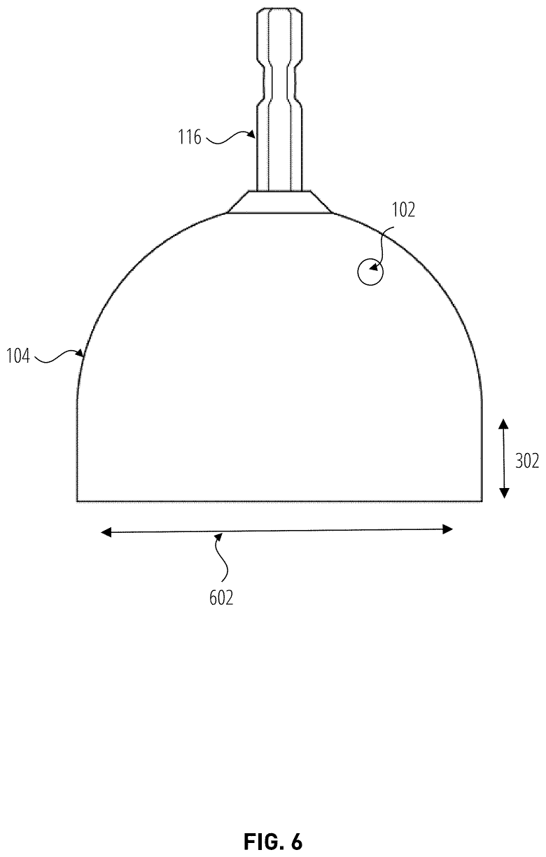

FIG. 6 illustrates a side view of a capper 104 in accordance with an embodiment of the invention. The air vent 102 and drill bit shaft member 116 can be seen as previously described. The size and proportions of the illustrated capper 104, including the dimensions of the interior cavity 218, are fabricated to accommodate a bottle cap 108 having a large inner diameter 602.

In conclusion, the embodiments of the bottle capper disclosed herein include, but are not limited to, a capper 104 having an upper portion 224 attached to a drill bit shaft member 116 and a lower portion 226.

The upper portion 224 may be a domed upper portion 112 as illustrated, but may be of any regular symmetrical shape that will rotate at speed in a balanced manner. The upper portion 224 has the drill bit shaft member 116 attached via a connection member 114 at a central upper edge in an upwardly extending manner.

The lower portion 226 is typically a cylindrical shape, but to may also be of any regular symmetrical shape that will rotate at speed in a balanced manner. The lower portion 226 has an interior cavity 218 sized and proportioned to accommodate a specific sized and shaped bottle cap 108. The interior cavity 218 has an inner diameter 306 that accommodates the external diameter 118 of the bottle cap 108. The interior cavity 218 is defined by an internal vertical edge 212 and an upper surface 220. The internal vertical edge 212 contains internal vertical splines 310 that correspond to external vertical splines 110 on the exterior edge 120 the bottle cap 108.

The internal vertical edge 212 may also comprise a retaining ring channel 214 that accommodates a retaining ring, such as an o-ring, to assist in retaining the bottle cap 108 inside the interior cavity 218. The upper surface 220 can be a continuous surface that abuts the internal vertical edge 212, or it can be a collar that abuts the internal vertical edge 212. When the upper surface 220 is a continuous surface, then a vent is typically formed between the interior cavity 218 and the exterior of the device. In certain embodiments of the invention, the connection point between the lower edge 208 and the internal vertical edge 212 of the interior cavity 218 is shaped to form a chamfered inner edge 202

In one embodiment of the invention, the upper portion 224, lower portion 226 and the drill bit shaft member 116 are of a unitary construction.

Regarding materials suitable for manufacture of the variously disclosed embodiments, metals and hard plastics are typical. Materials are usually selected from food grade components such that no leeching of material can occur over time. Additional advantages of food grade components is that they are easy to clean and do not support the growth of microorganisms.

Metals include, but are not limited to: steel, stainless steel, aluminum, copper, zinc and combinations thereof. Plastics can be selected from the group including, but not limited to: Lexan™; Nylon™; acrylics; polycarbonates; polyoxymethylene; high impact polystyrene; polypropylene; acrylonitrile butadiene styrene; and polyethylene. The plastics may be 3D printed, injection molded or extruded.

Examples of 3D printable plastics include, but are not limited to: polylactic acid, or PLA, this material has the benefit of being biodegradable as it is manufactured using renewable raw materials such as corn starch. ABS filament another type of 3D printing thermoplastic which contains a base of elastomers based on polybutadiene, making it more flexible, and resistant to shocks. ASA is a material that has similar properties to ABS, but has a greater resistance to UV rays. Polyethylene terephthalate, or PET, is ideal for fabricating larger more rigid frames. PETG, is a glycolyzed PET polymer that combines both the simplicity of PLA 3D printing and the strength of ABS, and it is 100% recyclable. Numerous other 3D printable polymers, hybrids and composites are known and considered to be within the scope of protection sought along with combinations thereof.

Plastics that are particularly suitable for injection molding include, but are not limited to: Lexan™; Nylon™; acrylics, which are particularly suitable for being tinted; polycarbonate (PC); polyoxymethylene (POM); polystyrene (PS); acrylonitrile butadiene styrene (ABS); polypropylene (PP); polyethylene (PE); thermoplastic polyurethane (TPU); and thermoplastic rubber (TPR) or combinations thereof.

Plastics that are particularly suitable for extrusion include but are not limited to: polyethylene (PE); polypropylene; acetal; acrylic; Nylon™; polyamides; polyvinyl chloride (PVC); acrylonitrile butadiene styrene (ABS); and polycarbonate or combinations thereof.

Merchandisable kits for sale to, for example, maple syrup bottling facilities, are considered within the scope of protection sought. The kits would contain a variety of cappers 104 having interior cavities 218 that are sized to accommodate the bottle caps 108 regularly used to seal maple syrup bottles. Similar kits can be assembled for other artisan producers of various products that are sold in jars and bottles including, but not limited to, liquid soaps, spirits and essential oils.

Methods of capping bottles and jars, using the various embodiments of the invention, are also considered within the scope of protection sought. The method comprises the steps of: (i) selecting an appropriately sized capper 104, having an interior cavity 218 that is sized and dimensioned to accommodate the cap to be torqued to the bottle; (ii) arranging the bottle caps 108 on a flat surface with the tops of the bottle caps 108 uppermost; (iii) securing the drill bit shaft member 116 of the capper 104 to a manually-controlled or manually operated device such as a drill; (iv) engaging the interior cavity 218 of the capper 104 with one of the bottle caps 108; (v) positioning the capper 104 over the bottle to be capped; and (vi) applying a torquing force by activation of the manually-controlled or manually operated device.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A bottle capper device for capping a bottle or a jar, said capper comprising:
an essentially cylindrical structure, said structure having:
an upper portion having an upper domed surface;
a shaft member, extending vertically from said domed surface;
a lower portion contiguous with said upper portion, said lower portion having defined within it an interior cavity having an interior diameter, an upper surface and an internal vertical edge;
a cylindrical vent channel, extending from an outer surface of said upper domed surface into said interior cavity; and
a plurality of vertical splines in spaced apart relationship around said internal vertical edge,
wherein said interior diameter of said interior cavity corresponds to an external diameter of a cap and said plurality of vertical splines on said internal vertical edge of said lower portion of said capper corresponds to a plurality of vertical splines of an outer edge of said cap.

2. The bottle capper of claim 1, wherein said shaft member is sized and configured to cooperate with a manually-controlled or manually operated device.

3. The bottle capper of claim 2, wherein said manually-controlled or manually operated device is a drill.

4. The bottle capper of claim 1, additionally comprising a retaining ring embedded in a retaining ring channel, said channel situated in said internal vertical edge of said lower portion.

5. The bottle capper of claim 4, wherein said retaining ring is an o-ring.

6. The bottle capper of claim 1, wherein said internal vertical edge of said inner portion is chamfered.

7. The bottle capper of claim 1, wherein said upper surface abuts to said internal vertical edge.

8. (canceled)

9. A method of capping a bottle or a jar, using the device of claim 1, said method comprising:
(i) selecting an appropriately sized capper, having an interior cavity that is sized and dimensioned to accommodate said cap to be torqued to said bottle or said jar;
(ii) arranging one or more of said caps on a flat surface with tops of said caps uppermost;
(iii) securing shaft member of the capper to a manually-controlled or manually operated device;
(iv) engaging said interior cavity of said capper with one of said one or more caps;
(v) positioning said capper over said bottle or said jar to be capped; and
(vi) applying a torquing force by activation of said manually-controlled or manually operated device.

10. A method of capping a bottle or a jar, using the device of claim 1, wherein said manually-controlled or manually operated device is a drill.

11. A kit for capping one or more bottles or jars, said kit comprising:
two or more capper devices, for torquing two or more differently dimensions caps, each capper device comprising:
an essentially cylindrical structure, said structure having:
an upper portion having an upper domed surface;
a shaft member, extending vertically from said domed surface;
a lower portion contiguous with said upper portion, said lower portion having defined within it an interior cavity having an interior diameter, an upper surface and an internal vertical edge;
a cylindrical vent channel, extending from an outer surface of said upper domed surface into said interior cavity; and
a plurality of vertical splines in spaced apart relationship around said internal vertical edge,
wherein one of said capper devices has a first interior diameter that corresponds to an external diameter of a cap, and at least one other of said capper devices has an interior diameter that is greater or lesser than the first internal diameter.

12. The kit of claim 11, wherein and said plurality of vertical splines on said internal vertical edge of one of said capper devices corresponds to a plurality of vertical splines on an outer edge of one of said two or more differently dimensions caps.

13. The kit of claim 12, wherein and said plurality of vertical splines on said internal vertical edge of another one of said capper devices corresponds to a plurality of vertical splines on an outer edge of another one of said two or more differently dimensions caps.

14. The kit of claim 11, wherein at least one of said capper devices has an interior diameter that is greater than the first internal diameter and at least one of said capper devices has a second interior diameter that is lesser than the first internal diameter.

15. The kit of claim 11, wherein said shaft member is sized and configured to cooperate with a manually-controlled or manually operated device.

16. The kit of claim 15, wherein said manually-controlled or manually operated device is a drill.

17. The kit of claim 11, additionally comprising a retaining ring embedded in a retaining ring channel, said channel situated in said internal vertical edge of said lower portion of at least one of said two or more capper devices.

18. The kit of claim 17, wherein said retaining ring is an o-ring.

19. The kit of claim 11, wherein said internal vertical edge of said inner portion is chamfered.

20. (canceled)
